(19) United States
(12) Patent Application Publication
(10) Pub. No.: US 2023/0029242 A1
(43) Pub. Date: Jan. 26, 2023

(54) SCREEN IMAGE GENERATION METHOD, SCREEN IMAGE GENERATION DEVICE, AND STORAGE MEDIUM

(71) Applicant: SINTOKOGIO, LTD., Nagoya-shi (JP)

(72) Inventors: Narihiro AKATSUKA, Nagoya-shi (JP); Naohisa NAKAMURA, Nagoya-shi (JP); Yoshitsugu TANAKA, Nagoya-shi (JP)

(73) Assignee: SINTOKOGIO, LTD., Nagoya-shi (JP)

(21) Appl. No.: 17/832,861

(22) Filed: Jun. 6, 2022

(30) Foreign Application Priority Data
Jul. 16, 2021 (JP) 2021-118219

(51) Int. Cl. G05B 19/05

(52) U.S. Cl. CPC G05B 19/054; G05B 19/052; G05B 19/058

(57) ABSTRACT

A screen image generation device for generating a screen image indicating a state of a facility in a production plant is provided which ensures a real-time property of a management screen image needed in actual production plants and reduce required levels of making a network faster in speed and wider in bandwidth. A server functioning as the device performs first acquisition of regularly acquiring first data transmitted from a sensor and concerning the facility at intervals of a first time, second acquisition of regularly acquiring second data transmitted from a controller and concerning the facility at intervals of a second time shorter than the first time, third acquisition of acquiring, in real time, an alert irregularly transmitted from the controller and concerning the facility, and generation of generating the management screen image indicating the state of the facility in accordance with the first data, the second data, and the alert.

This Nonprovisional application claims priority under 35 U.S.C. § 119 on Patent Application No. 2021-118219 filed in Japan on Jul. 16, 2021, the entire contents of which are hereby incorporated by reference.

### TECHNICAL FIELD

The present invention relates to a screen image generation method and a screen image generation device for generating a management screen image that indicates states of a facility in a production plant. The present invention relates also to a storage medium storing a program for causing a computer to operate as the screen image generation device.

### BACKGROUND ART

There is a known management system for managing facilities in a production plant. Such a management system includes a sensor installed in the production plant, and gathers information from the facilities and information from the sensor to manage the facilities.

For example, according to a production line monitoring system disclosed in Patent Literature 1, a production line programmable logic controller (PLC), data gathering PLC, and a gateway terminal are installed in a production site, and a server is installed in a remote location. The data gathering PLC acquires production line data outputted from the production line PLC and indicating an operational status of a facility and sensor data which is a value outputted from each of various sensors, and outputs the acquired production line data and sensor data to the gateway terminal. The gateway terminal receives the production line data and the sensor data outputted from the data gathering PLC, and transmits the received data to the server installed in a remote location via a network. The server stores the production line data and the sensor data transmitted from the gateway terminal, and makes these various kinds of data accessible from a client terminal.

Further, according to an operation maintenance and support system disclosed in Patent Literature 2, operation handling equipment, sensor equipment, a power switchboard, and a data logger are installed within plant premises. The data logger gathers an operational state of the operation handling equipment and measurement data of the sensor equipment from a PLC inside the power switchboard. The data logger makes the measurement data accessible from a handheld information terminal of an operational manager via a wireless network. Additionally, the data logger transmits the measurement data to an information terminal device of a professional engineer in a remote location via a network.

### CITATION LIST

### Patent Literature

Patent Literature 1

Japanese Patent Application Publication, Tokukai, No. 2018-63715 (Publication Date: Apr. 19, 2018)

Patent Literature 2

Japanese Patent Application Publication, Tokukai, No. 2004-326468 (Publication Date: Nov. 18, 2004)

### SUMMARY OF INVENTION

### Technical Problem

In a management system in which a management screen image indicating a state of a facility in a production plant is generated in accordance with information acquired from the facility and a sensor, the problem as below can arise. Specifically, it is necessary to acquire information from the facility and the sensor at shorter time intervals to update the management screen image with the state of the facility in a more real-time manner. However, information acquisition from the facility or the sensor at shorter time intervals creates the need for a network for transmitting such information that is faster in speed and wider in bandwidth, and therefore increases operational costs. Conversely, failing to make a network faster and wider to reduce operational costs makes it difficult to update the management screen image with the state of the facility in real time. This makes it impossible to quickly take necessary measures when the state of the facility suddenly changes.

An aspect of the present invention has been made in view of the above problem, and an object thereof is to provide a screen image generation method and a screen image generation device that are for generating a management screen image indicating a state of a facility in a production plant and that both ensure a real-time property of the management screen image needed in actual production plants and reduce required levels of making a network faster in speed and wider in bandwidth.

### Solution to Problem

It is preferable to monitor, in real time, an alert transmitted from a controller incorporated in a facility. That is because failing to quickly take a measure in response to the alert is highly likely to immediately cause a device failure. It is preferable to regularly monitor data (e.g. data representing power consumption of the facility) transmitted from the controller incorporated in the facility and data (data representing a temperature of the facility) transmitted from a sensor accompanying the facility. That is because failing to quickly respond to such kinds of data is unlikely to immediately cause a device failure.

As above, information acquired, from the controller and the sensor, for generating the management screen image is classified into information which is such that failing to acquire the information in real time is highly likely to cause a problem and information which is such that even regular acquisition of the information is less likely to cause a problem. Accordingly, performing regular acquisition of information classified into the latter while performing real-time acquisition of information classified into the former enables both ensuring of a real-time property of the management screen image needed in actual production plants and reductions in required levels of making a network faster in speed and wider in bandwidth. The inventors of the present application have arrived at an aspect of the present invention on the basis of the above consideration.

A screen image generation method in accordance with an aspect of the present invention is for generating a management screen image indicating a state of a facility of a production plant, the method including, first acquisition, second acquisition, third acquisition, and generation, the first acquisition, the second acquisition, the third acquisition, and the generation being performed by one or more processors. A screen image generation device in accordance with an aspect of the present invention is for generating a management screen image indicating a state of a facility of a production plant, the device including one or more processors for performing first acquisition, second acquisition, third acquisition, and generation.

The first acquisition is processing of regularly acquiring first data concerning the facility and transmitted from a sensor accompanying the facility. The second acquisition is processing of regularly acquiring second data concerning the facility and transmitted from a controller incorporated in the facility. The third acquisition is processing of acquiring, in real time, an alert concerning the facility and irregularly transmitted from the controller. The generation is processing of generating a management screen image indicating a state of the facility in accordance with the first data, the second data, and the alert.

### Advantageous Effects of Invention

An aspect of the present invention enables both ensuring of a real-time property of a management screen image needed in actual production plants and reductions in required levels of making a network faster in speed and wider in bandwidth.

### BRIEF DESCRIPTION OF DRAWINGS

FIG. 1 is a block diagram illustrating a configuration of a management system in accordance with an embodiment of the present invention.

FIG. 2 is a block diagram illustrating a configuration of a server of the management system in FIG. 1.

FIG. 3 is a flowchart illustrating a processing flow in a screen image generation method performed by the server in FIG. 2.

FIG. 4 is a sequence diagram illustrating a data flow in the screen image generation method illustrated in FIG. 3.

FIG. 5 is a screen configuration diagram illustrating a specific example of a management screen image generated by the screen image generation method illustrated in FIG. 3.

### DESCRIPTION OF EMBODIMENTS

### Configuration of Management System

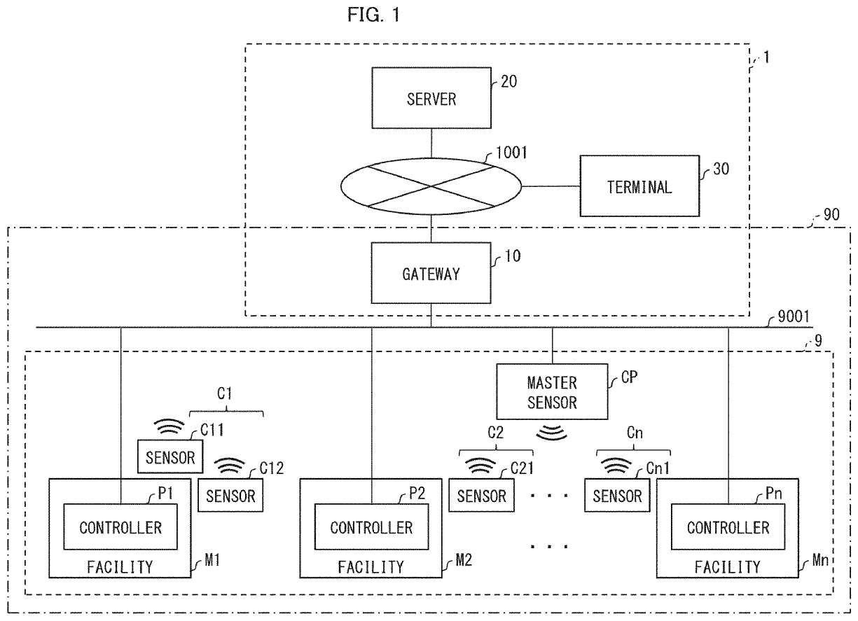

The following description will discuss a configuration of a management system 1 in accordance with an embodiment of the present invention with reference to FIG. 1. FIG. 1 is a block diagram illustrating a configuration of the management system 1.

A management system 1 is a system for managing a production line 9, and includes: a gateway 10; a server 20 (an example of the “screen image generation device” in the claims); and a terminal 30, as illustrated in FIG. 1.

The production line 9 includes n facilities M1 to Mn (n is a natural number not less than 1) installed in a production plant 90. Each facility Mi (i is a natural number not less than 1 and not more than n) incorporates a controller Pi. The controller Pi has functions of (1) identifying an internal state of the facility Mi and generating data representing the identified state, and (2) generating, in accordance with the identified state, an alert concerning the facility Mi. Further, a sensor group Ci accompanies each facility Mi. Each sensor group Ci has a function of detecting an external state of the facility Mi and generating a signal representing the detected state. Inside the production plant 90, a master sensor CP is also installed. The master sensor CP is connected to each sensor group Ci via a wireless sensor network. The master sensor CP has a function of acquiring, from each sensor group Ci accompanying a corresponding facility Mi, the signal representing the external state of the corresponding facility Mi, and generating data representing the external state of the corresponding facility Mi. The configuration of the production line 9 will be described in detail in another section.

The gateway 10, disposed inside the production plant 90, is connected to facilities M1 to Mn and to the master sensor CP via a LAN 9001. The gateway 10 acquires, from each controller Pi incorporated in a corresponding facility Mi, data representing an internal state of the corresponding facility Mi and an alert concerning the corresponding facility Mi. The gateway 10 also acquires, from the master sensor CP, data representing an external state of each facility Mi. The server 20, disposed outside the production plant 90, is connected to the gateway 10 via a wide area network (WAN) 1001. The server 20 acquires, from the gateway 10, the data representing the external state of, the data representing the internal state of, and the alert concerning each facility Mi. Further, the server 20 generates a management screen image G for managing the production line 9, in accordance with the data and alert concerning each facility Mi. The terminal 30, disposed at any place inside or outside the production plant 90, is connected to the server 20 via the WAN 1001. The terminal acquires the management screen image G from the server 20, and displays the management screen image G acquired. The configuration of the server 20 and a specific example of the management screen image G will be described in detail in another section.

For example, the terminal 30 may be a notebook computer, a smartphone, a tablet, or the like carried by a person in charge of the maintenance of each facility Mi. Alternatively, the terminal 30 may be installed in a support center responsible for the maintenance of the production line 9. Alternatively, the terminal 30 may be installed in the production plant 90 so that a person on-site responsible for the production line 9 can use the terminal 30. Although illustrated in FIG. 1 is an example in which the management system 1 includes a single terminal 30, the management system 1 may include a plurality of terminals 30. Optionally, for example, one or more of the plurality of terminals 30 are carried by the above-described person in charge, any other one or more are installed in the above-described support center, and any other one or more are installed in the production plant 90.

### Details of Production Line

The following description will discuss the details of the production line 9 with reference again to FIG. 1. The production line 9 include: the n facilities M1 to Mn; the n sensor groups C1 to Cn; and a master sensor CP, as described above. In the present embodiment, it is assumed that the production line 9 is for producing castings, although the present invention is not limited thereto.

Each facility Mi incorporates the controller Pi. Examples of the facility Mi include, but not limited to, a molding machine, a blasting device, and a dust collector.

Each controller Pi controls the corresponding facility Mi. The controller Pi is, for example, a programmable logic controller (PLC) that operates according to a program for controlling each section of the facility Mi. Each controller Pi identifies an internal state of the corresponding facility Mi and generates data representing the identified state. Each controller Pi also generates, in accordance with the identified state, an alert concerning the corresponding facility Mi. Examples of the internal state include an operational state, power consumption, operating time, the number of inspections of a predetermined component, a date of replacement of a predetermined component, and a time required for a predetermined work. However, the internal state is not limited thereto. Examples of the alert include an anomaly alert indicating an anomaly in the facility Mi or a predetermined component and a warning alert indicating that an anomaly in the facility Mi or a predetermined component is highly likely. However, the alert concerning the facility Mi is not limited thereto. The identification, by the controller Pi, of the internal state of the facility Mi is implemented through reference to, for example, a signal outputted from a sensor incorporated in the facility Mi and/or a parameter (e.g., a setting value for defining the operation of the facility Mi) stored in a memory incorporated in the facility Mi.

Each controller Pi is connected to the gateway 10 (described later) via the local area network (LAN) 9001 set up in the production plant 90. The LAN 9001 is made up of, for example, a wired LAN, a wireless LAN, or a combination thereof. In response to a request from the gateway 10 or spontaneously, each controller Pi transmits, to the gateway 10, data representing the internal state of the corresponding facility and an alert concerning the corresponding facility Mi. The data transmitted by the controller Pi to the gateway 10 at each transmission timing may be data generated immediately before the current transmission timing, or may be a chronologically-arranged data series generated from the last transmission timing to the current transmission timing. The same applies to the alert transmitted by the controller Pi to the gateway at each transmission timing. The communications between the controller Pi and the gateway 10 may be implemented by a LAN connection as described herein or by a serial connection.

Each sensor group Ci includes mi sensors Ci1 to Cimi (mi is a natural number not less than 1) accompanying the facility Mi. As used herein, the word “accompanying” means retrofitting the facility Mi to detect the external state of the facility Mi. Each sensor Cij (j is a natural number not less than 1 and not more than mi) can be installed inside or outside the facility Mi. Although the sensors Ci1 to Cimi accompany each facility Mi in the present embodiment, the present invention is not limited thereto. Specifically, the production line 9 may include a facility Mi that is not accompanied by a sensor. In the example in FIG. 1, the facility M1 is accompanied by two sensors C11 and C12. The facility M2 is accompanied by a sensor C21. The facility Mn is accompanied by a sensor Cml.

Each sensor Cij detects an external state of the facility Mi and generates a signal representing the detected state. Examples of the external state include vibration of the facility Mi and temperature of the facility Mi. The vibration of the facility Mi can be at least any of displacement, velocity, and acceleration of the vibration. The examples also include a pressure difference between two rooms (for example, a clean room and a dirty room in a dust collector) in the facility Mi. The examples also include an electric current in an electronic component (for example, a motor for driving a component to rotate) incorporated in the facility Mi. The examples also include working oil dirtiness in the facility Mi. The examples also include the temperature of molten metal put into the facility Mi. However, the external state is not limited thereto. Examples of the sensor Cij include, but not limited to, a vibration sensor, a current transformer (CT) sensor, a manometer, an oil quality sensor, a non-contact temperature sensor, and can be any analog sensor (typically having an output of 4 mA to 20 mA).

Each sensor Cij is communicatively connected to the master sensor CP. For example, each sensor Cij is communicatively connected to the master sensor CP via the wireless sensor network. The wireless sensor network is formed by, for example, short-range radio communication such as infrared communication or Bluetooth (registered trademark), or the like. Further, communication of signals between the master sensor CP and each sensor Cij is made according to a predetermined protocol. Any sensor can be easily added by retrofit as a sensor accompanying any facility Mi, provided that the sensor (i) includes a communications interface for connection with the wireless sensor network to which the master sensor CP is connected and (ii) communicates information according to the protocol with which the master sensor CP is compliant.

Each sensor Cij may be configured to periodically transmit, to the master sensor CP, a signal, detected by the sensor Cij, representing an external state of the facility Mi. Alternatively, each sensor Cij may be configured to transmit, to the master sensor CP, the detected signal representing the external state, at the time when the detected external state meets a predetermined requirement. Alternatively, each sensor Cij may be configured to transmit, to the master sensor CP, the detected signal representing the external state, at the time of receiving a request from the master sensor CP.

The master sensor CP receives, from each sensor Cij, the signal representing the external state of the facility Mi. A timing for the master sensor CP receiving the signal from each sensor Cij depends on the configuration of the sensor Cij. The master sensor CP generates data representing the external state of each facility Mi, from a signal received from each of the sensors Ci1 to Cimi accompanying the facility Mi. The master sensor CP then stores, in a memory (not illustrated) of the master sensor CP, the data representing the external state of each facility Mi, in association with the identification information of the facility Mi. Associating the data representing the external state of the facility Mi with the facility Mi may be performed in the master sensor CP as described here, in the gateway 10, or in the server 20.

The master sensor CP is also connected to the gateway 10 via the LAN 9001. The master sensor CP reads from the memory and transmits to the gateway 10, information representing the external state of each facility Mi, in response to a request from the gateway 10 or spontaneously. The data transmitted by the master sensor CP to the gateway 10 at each transmission timing may be data generated immediately before the current transmission timing, or may be a chronologically-arranged data series generated from the last transmission timing to the current transmission timing.

Although the production line 9 includes a single master sensor CP in the present embodiment, the production line 9 may include a plurality of master sensors each having the same configuration that the master sensor CP has. In that case, each sensor Cij is connected to any of the plurality of master sensors. At least one and at least another one of the plurality of master sensors may be connected to respective wireless sensor networks different from each other. At least one and at least another one of the plurality of master sensors may use respective protocols different from each other to communicate with each sensor Cij.

### Configuration of Server 20

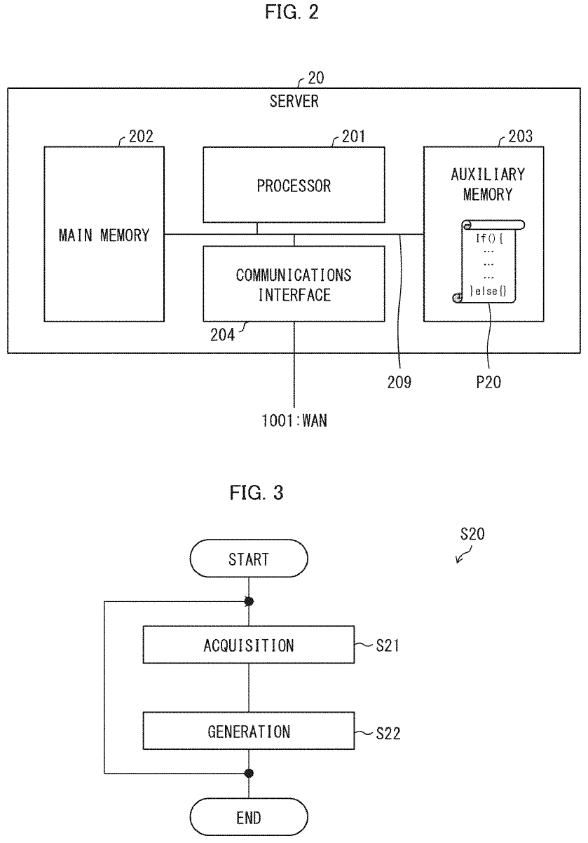

The following description will discuss the server 20 in detail with reference to FIG. 2. FIG. 2 is a block diagram illustrating a hardware configuration of the server 20.

The server 20 is formed by a computer including: a processor 201; a main memory 202; an auxiliary memory 203; and a communications interface 204, as illustrated in FIG. 2. The main memory 202 and the auxiliary memory 203 are examples, in the present invention, of a memory included in the server. The communications interface 204 is an example, in the present invention, of a communications interface included in the server.

The processor 201, the main memory 202, the auxiliary memory 203, and the communications interface 204 are connected to each other via a bus 209. Examples of the processor 201 include one or more microprocessors, one or more digital signal processors, one or more microcontrollers, and a combination thereof. Examples of the main memory 202 include one or more semiconductor RAMs. Examples of the auxiliary memory 203 include one or more HDDs, one or more SSDs, and a combination thereof. The auxiliary memory 203 may be partially or wholly online storage connected via the communications interface 204. The communications interface 204 is connected to the WAN 1001.

The auxiliary memory 203 stores a program P20 for causing the processor 201 to perform a screen image generation method S20 in the server 20 (described later). The processor 201 loads, on the main memory 202, the program P20 stored in the auxiliary memory 203, and performs each instruction included in the program P20 having been loaded. In this manner, the processor 201 performs each step included in the screen image generation method S20. The auxiliary memory 203 also stores various kinds of data to which the processor 201 refers to perform the screen image generation method S20.

The communications interface 204 is for communicating with the gateway 10 and the terminal 30 via the WAN 1001. Examples of the communications interface 204 include an Ethernet (registered trademark) interface.

Although the processor 201 performs the screen image generation method S20 according to the program P20 stored in the auxiliary memory 203, which is an internal storage medium, in this description, the present embodiment is not limited thereto. Specifically, the processor 201 may perform the screen image generation method S20 according to the program P20 stored in an external storage medium. In this case, a computer-readable “non-transitory tangible medium” such as a tape, a disk, a card, a semiconductor memory, or a programmable logic circuit can be used as the external storage medium. Alternatively, the processor 201 may perform the screen image generation method S20 according to the program P20 obtained over a network to which the processor 201 is connected via the communications interface 204.

Although a single computer implements the functions of the server 20 in this description, the present embodiment is not limited thereto. Specifically, a plurality of computers configured to be able to communicate with each other may implement the functions of the server 20. This allows these computers to perform the respective steps of the screen image generation method S20 in parallel.

### Flow of Screen Image Generation Method

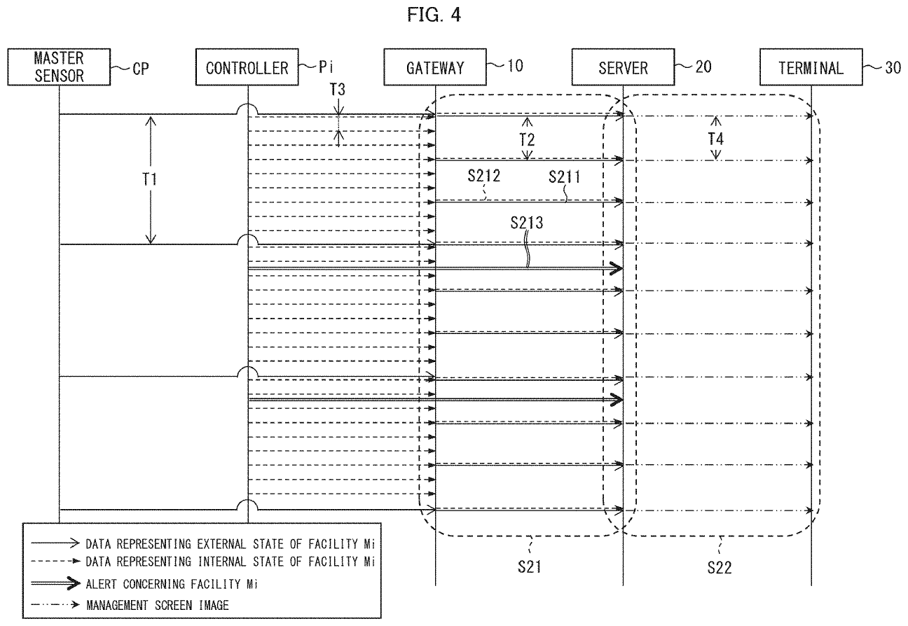

The following description will discuss the flow illustrating the screen image generation method S20 performed by the server 20, with reference to FIGS. 3 and 4. FIG. 3 is a flowchart illustrating a processing flow in the screen image generation method S20. FIG. 4 is a sequence diagram illustrating a data flow in the screen image generation method S20.

The screen image generation method S20 includes: acquisition S21; and generation S22, as illustrated in FIG. 3. The acquisition S21 is processing of acquiring, by the processor 201, data and an alert concerning each facility Mi. The generation S22 is processing of generating, by the processor 201, the management screen image G indicating a state of the facility Mi, in accordance with the data and the alert acquired in the acquisition S21. The management screen image G generated in the generation S22 is transmitted to the terminal 30.

The acquisition S21 performed by the processor 201 includes: first acquisition S211; second acquisition S212; and third acquisition S213, as illustrated in FIG. 4.

The first acquisition S211 is processing of regularly acquiring, by the processor 201 from the gateway 10, data (an example of the “first data” in the claims) transmitted from the sensor Cij accompanying the facility Mi and representing an external state of the facility Mi. The master sensor CP regularly transmits, to the gateway 10, the data representing an external state the facility Mi at intervals of a first time T1. Meanwhile, the first acquisition S211 is regularly performed at intervals of a second time T2 shorter than the first time T1. For example, the first time T1 is 10 minutes, and the second time T2 is not more than 10 minutes. This enables updating, at a necessary and sufficient frequency, of the external state to be displayed in the management screen image G.

The second acquisition S212 is processing of regularly acquiring, by the processor 201 from the gateway 10, data (an example of the “second data” in the claims) transmitted from the controller Pi incorporated in the facility Mi and representing an internal state of the facility Mi. The controller Pi transmits, to the gateway 10, the data representing an internal state of the facility Mi, irregularly, or regularly at intervals of a third time T3 shorter than the second time T2. In FIG. 4, the latter case is illustrated. Meanwhile, the second acquisition S212 is regularly performed at intervals of the second time T2, as is the first acquisition S211. Data acquired by the processor 201 in the second acquisition S212 is the data accumulated in the gateway 10 during the second time T2 and representing the internal states of the facility Mi. This enables updating, at a necessary and sufficient frequency, of the internal state to be displayed in the management screen image G. The second acquisition S212 may be performed concurrently with the first acquisition S211. This enables a reduction in the number of times of connection between the gateway 10 and the server 20, in comparison with a case of not being performed concurrently, and consequently enables communication cost reduction.

The third acquisition S213 is processing of acquiring, by the processor 201 from the gateway 10, an alert (an example of the “alert” in the claims) irregularly transmitted from the controller Pi incorporated in the facility Mi and concerning the facility Mi. The third acquisition S213 is performed in real time, at the time of receiving, by the gateway 10, an alert from the controller Pi. The timing for transmitting, by the controller Pi, an alert to the gateway 10 may coincide with any of the timings for transmitting, by the controller Pi, data representing an internal state of the facility Mi to the gateway 10.

The generation S22 is repeatedly performed at intervals of a fourth time T4 equal to or shorter than the second time T2. In FIG. 4, a case where the fourth time T4 is equal to the second time T2 is illustrated.

As above, the master sensor CP regularly transmits data representing an external state of the facility Mi, to the gateway 10 at intervals of the first time T1. In this case, data transmitted by the master sensor CP to the gateway at each transmission timing is data chronologically representing external states of the facility Mi detected from the last transmission timing to the current transmission timing.

As above, the controller Pi incorporated in the facility Mi irregularly transmits, to the gateway 10, data representing an internal state of the facility Mi. In this case, the timing for data transmission by the controller Pi is, for example, the time when the internal state changes. In this case, data transmitted by the controller Pi to the gateway 10 at each transmission timing is data representing an internal state having changed. Alternatively, the controller Pi incorporated in the facility Mi regularly transmits data representing an internal state of the facility Mi, to the gateway 10 at intervals of the third time T3, as described above. In this case, data transmitted by the controller Pi to the gateway 10 at each transmission timing is data chronologically representing internal states of the facility Mi detected between the last transmission timing and the current transmission timing.

Additionally, the controller Pi incorporated in the facility Mi irregularly transmits, for example, an alert concerning the facility Mi, to the gateway 10. In this case, the timing for alert transmission by the controller Pi is, for example, a time when the internal state of the facility Mi changes. In this case, an alert transmitted by the controller Pi to the gateway 10 at each transmission timing is an alert generated in accordance with the internal state having changed.

### Specific Example of Management Screen Image

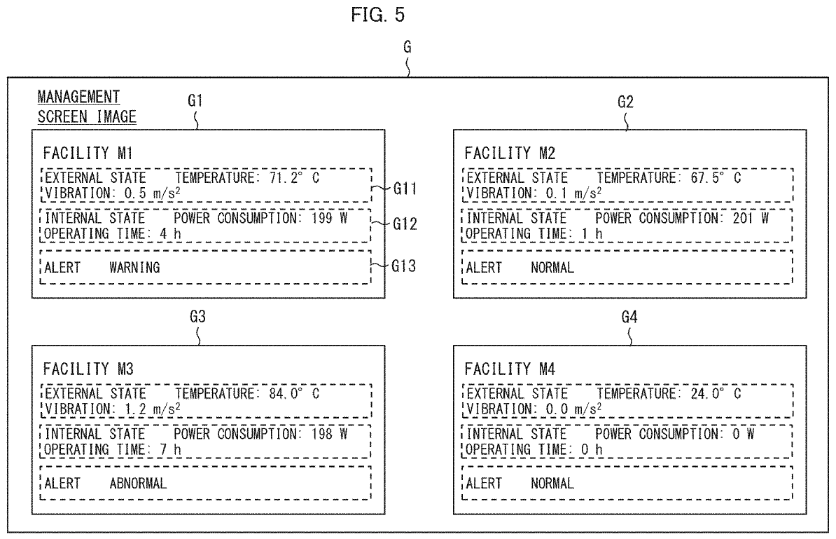

The following description will discuss a specific example of the management screen image G generated by the server 20 and displayed by the terminal 30, with reference to FIG. 5. FIG. 5 is a screen configuration diagram illustrating a specific example of the management screen image G. The management screen image G in accordance with the present specific example is a management screen image simultaneously indicating the states of the four facilities M1 to M4.

The management screen image G includes: a first display region G1; a second display region G2; a third display region G3; and a fourth display region G4, as illustrated in FIG. 5.

The first display region G1 is a display region for indicating states of the first facility Ml. The second display region G2 is a display region for indicating states of the second facility M2. The third display region G3 is a display region for indicating states of the third facility M3. The fourth display region G4 is a display region for indicating states of the fourth facility M4. These four display regions G1 to G4 have the same configuration. The following description will therefore discuss the first display region G1, and the descriptions of the other display regions G2 to G4 are omitted.

The first display region G1 includes: an external state display region G11; an internal state display region G12; and an alert display region G13, as illustrated in FIG. 5.

The external state display region G11 is a region for displaying an external state of the facility M1 represented by the data acquired in the first acquisition S211 above. The external state display region G11 illustrated in FIG. 5 displays the temperature and vibration (more specifically, an acceleration of the vibration) of the facility M1 as the external state.

The internal state display region G12 is a region for displaying an internal state of the facility M1 represented by the data acquired in the second acquisition S212 above. The internal state display region G12 illustrated in FIG. 5 displays power consumption and operating time of the facility M1 as the internal state.

The alert display region G13 is a region for displaying an alert concerning the facility M1 acquired in the third acquisition S213 above. The alert display region G13 illustrated in FIG. 5 displays a warning alert (a character string of “WARNING”) as the alert concerning the facility M1. When no alert concerning the facility M1 is acquired in the third acquisition S213, a character string of, for example, “NORMAL” is displayed in the alert display region G13.

According to the screen image generation method S20 and the server 20 in accordance with the present embodiment, the processor 201 performs the first acquisition S211, the second acquisition S212, the third acquisition S213, and the generation S22. This enables both real-time acquisition of an alert transmitted from the controller Pi incorporated in the facility Mi and regular acquisition, at intervals of the second time T2, of data transmitted from the sensor Cij accompanying the facility Mi and the controller Pi incorporated in the facility Mi. It is therefore possible to both ensure a real-time property of the management screen image G needed when the production plant 90 actually operates and reduce required levels of making a network faster in speed and wider in bandwidth.

Data acquired by the processor 201 in the second acquisition S212 is the data accumulated in the gateway 10 during the second time T2. This enables a reduction in the frequency of communication with the gateway 10, compared with a case of real-time acquisition of data transmitted from the controller Pi irregularly or regularly.

The generation S22 is repeatedly performed at intervals of the fourth time T4 equal to or shorter than the second time T2. This enables a further improvement in a real-time property of the management screen image G generated.

In the first acquisition S211 and the second acquisition S212, data indicating a temperature or a vibration of the facility Mi and an operational state of the facility Mi is acquired. This enables generation of the management screen image G that reflects the temperature or vibration and the operational state of the facility Mi.

### Supplementary Note

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Management system

### 10: Gateway

20: Server (management screen image generation device)

### 201: Processor

202: Main memory
203: Auxiliary memory
204: Communications interface

### 30: Terminal

90: Production plant
9: Production line

### Mi: Facility

### Pi: Controller

CP: Master sensor
Ci: Sensor group

1. A screen image generation method for generating a management screen image indicating a state of a facility in a production plant, the method comprising:
first acquisition of regularly acquiring first data transmitted from a sensor accompanying the facility and concerning the facility;
second acquisition of regularly acquiring second data transmitted from a controller incorporated in the facility and concerning the facility;
third acquisition of acquiring, in real time, an alert irregularly transmitted from the controller incorporated in the facility and concerning the facility; and
generation of generating a management screen image indicating the state of the facility in accordance with the first data, the second data, and the alert,
the first acquisition, the second acquisition, the third acquisition, and the generation being performed by one or more processors.

2. The method according to claim 1, wherein
the sensor regularly transmits the first data at intervals of a first time,
the processor regularly acquires the first data at intervals of a second time shorter than the first time in the first acquisition, and
the processor regularly acquires the second data at intervals of the second time in the second acquisition.

3. The method according to claim 2, wherein
the controller transmits, to a gateway, the second data irregularly, or regularly at intervals of a third time shorter than the second time, and
the processor regularly acquires, from the gateway, the second data accumulated in the gateway at intervals of the second time in the second acquisition processing.

4. The method according to claim 2, wherein
the processor keeps updated the state of the facility indicated in the management screen image by repeatedly performing the generation at intervals of a fourth time equal to or shorter than the second time.

5. The method according to claim 1, wherein
the first data indicates a temperature or a vibration of the facility, and the second data indicates an operational state of the facility.

6. A screen image generation device for generating a management screen image indicating a state of a facility in a production plant, the device comprising
one or more processors,
the one or more processors configured to perform
first acquisition of regularly acquiring first data transmitted from a sensor accompanying the facility and concerning the facility,
second acquisition of regularly acquiring second data transmitted from a controller incorporated in the facility and concerning the facility,
third acquisition of acquiring, in real time, an alert irregularly transmitted from the controller incorporated in the facility and concerning the facility,
generation of generating a management screen image indicating the state of the facility in accordance with the first data, the second data, and the alert.

7. A non-transitory storage medium storing a program for causing a computer to operate as a screen image generation device according to claim 6, the program causing one or more processors of the computer to perform the first acquisition, the second acquisition, the third acquisition, and the generation.
